(19) United States
(12) Patent Application Publication
(10) Pub. No.: US 2024/0147507 A1
(43) Pub. Date: May 2, 2024

(54) INTERFERENCE CANCELLATION CAPABILITY AWARENESS FOR SIDELINK COMMUNICATIONS

(71) Applicant: QUALCOMM Incorporated, San Diego, CA (US)

(72) Inventors: Shuanshuan Wu, San Diego, CA (US); Junyi Li, Fairless Hills, PA (US); Kapil Gulati, Belle Mead, NJ (US)

(21) Appl. No.: 18/050,589

(22) Filed: Oct. 28, 2022

(51) Int. Cl. H04W 72/04; H04L 1/00; H04W 72/02

(52) U.S. Cl. CPC H04W 72/048; H04L 1/0003; H04W 72/02

(57) ABSTRACT

The present disclosure relates to a method for wireless communication at a user equipment. The method comprises determining an interference cancellation, IC, capability for a sidelink communication, wherein the sidelink communication is to be transmitted to one or more other UEs and reporting the determined IC capability for the sidelink communication to a base station. The method also comprises receiving, from the base station, an indication of resources allocated for the sidelink communication based on the reported IC capability and transmitting the sidelink communication to the one or more other UEs using the allocated resources.

### BACKGROUND

### Field of the Disclosure

The following relates to wireless communications, and particularly to techniques for interference cancellation capability awareness for sidelink communications.

### Description of Related Art

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some aspects, two or more UEs may communicate directly using one or more sidelink channels (e.g., without using a base station as an intermediary to communicate with one another). Sidelink communication is direct communication between two (or more) UEs without the participation of a base station in the transmission and reception of data traffic. For example, the UEs may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. The sidelink channels may include one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR. In this case, the UE may perform scheduling operations, resource selection operations, and/or other operations described elsewhere herein as being performed by the base station.

3GPP NR Rel-16 specifies three cast types for sidelink communication: unicast, which relates to direct communication between a pair of UEs, broadcast, in which a single transmit UE sends messages to be received by all UEs within a radio transmission range of the transmit UE and groupcast (or multicast), in which a transmit UE sends messages to a set of receive UEs which are members of a group. Two modes of resource allocation are specified for NR sidelink. In Mode 1 resource allocation, a base station allocates resources to a transmit UE for a sidelink transmission. A sidelink configured grant may be configured for the UE via RRC signaling for immediate use. Alternatively, the base station may grant the UE permission to activate or deactivate allocated resources using downlink control information (DCI) messages. In Mode 2 resource allocation, the transmit UE performs resource allocation autonomously based on a sensing procedure.

UEs capable of interference cancellation (IC) on received sidelink communications may be improved or become available in future. However, realization of gains associated with such receiver IC capability may not be achievable with available sidelink procedures or signaling.

### BRIEF SUMMARY

According to Mode 1 scheduling procedures, a transmit UE sends a scheduling request and sidelink buffer status report to the base station for sidelink scheduling. The base station sends DCI to the transmit UE to allocate one or multiple resources for the sidelink communication to be transmitted by the transmit UE. The transmit UE then transmits sidelink control information (SCI) and data in the allocated resource to one or more receive UEs in accordance with the cast type. The SCI transmitted by the transmit UE may also indicate the allocated resources in future slots as being reserved.

A sidelink advanced receiver is a UE that is capable of performing interference cancellation (IC) on received sidelink communications. Such a receive UE decodes a first transmission received in a resource, performs interference cancellation and then decodes another transmission received in the same resource. These advanced receivers may therefore be able to decode sidelink communications sent in overlapping resources. This is particularly useful for broadcast and groupcast sidelink communications, where all transmissions may be desired signals from a receive UE perspective. Thus, IC capability at a receiver may significantly improve sidelink communication reliability and increase network capacity. However, according to current signaling procedures for sidelink communication, the base station is not aware of possible IC capability of the receive UEs to which a sidelink communication is to be transmitted, and so it may not be possible to realize IC gains associated with receiver IC capability.

The present application is directed towards signaling procedures to enable IC aware sidelink scheduling, such as Mode 1 scheduling, considering different case types, as well as facilitating receive UE operation. By providing the base station with an awareness of the IC capability of receive UEs to which a sidelink communication is to be transmitted, IC gains associated with advanced receivers may be realized. For example, where a sidelink communication is to be transmitted to a UE or UEs that do not have IC capability, the sidelink scheduling may be done in a legacy manner, that is, so that the resources allocated to the transmit UE for the sidelink communication do not overlap with those allocated to another transmission. However, where the sidelink communication is to be transmitted to a UE or UEs that are capable of performing interference cancellation, the base station may schedule the sidelink communication in a resource that overlaps with another transmission, thereby improving capacity.

According to an aspect, there is provided a method for wireless communication at a UE. The method comprises determining an interference cancellation (IC) capability for a sidelink communication, wherein the sidelink communication is to be transmitted to one or more other UEs, reporting the determined IC capability for the sidelink communication to a base station, receiving, from the base station, an indication of resources allocated for the sidelink communication based on the reported IC capability, and transmitting the sidelink communication to the one or more other UEs using the allocated resources. This may allow a base station to be made aware of an IC capability for a sidelink communication so that IC gain may be realized.

According to an aspect, there is provided an apparatus for wireless communication at a UE. The apparatus comprises means for determining an interference cancellation (IC) capability for a sidelink communication, wherein the sidelink communication is to be transmitted to one or more other UEs, means for reporting the determined IC capability for the sidelink communication to a base station, means for receiving, from the base station, an indication of resources allocated for the sidelink communication based on the reported IC capability, and means for transmitting the sidelink communication to the one or more other UEs using the allocated resources.

According to an aspect, there is provided an apparatus for wireless communication at a UE. The apparatus comprises a memory and one or more processors operatively coupled to the memory, the memory and the one or more processors configured to determine an interference cancellation (IC) capability for a sidelink communication, wherein the sidelink communication is to be transmitted to one or more other UEs, report the determined IC capability for the sidelink communication to a base station, receive, from the base station, an indication of resources allocated for the sidelink communication based on the reported IC capability, and transmit the sidelink communication to the one or more other UEs using the allocated resources.

According to an aspect, there is provided a non-transitory computer-readable medium storing code for wireless communication at a UE. The code includes instructions executable by a processor to determine an interference cancellation (IC) capability for a sidelink communication, wherein the sidelink communication is to be transmitted to one or more other UEs, report the determined IC capability for the sidelink communication to a base station, receive, from the base station, an indication of resources allocated for the sidelink communication based on the reported IC capability, and transmit the sidelink communication to the one or more other UEs using the allocated resources.

Some examples of the method, apparatuses, and non-transitory computer-readable medium described herein may further include operations, features, means, or instructions for receiving an indication of IC capability from each of the one or more other UEs to which the sidelink communication is to be transmitted, wherein determining the IC capability for the sidelink communication comprises determining the IC capability for the sidelink communication based on the one or more received indications. This may allow an IC capability to be determined for a single UE to which a sidelink communication is to be unicast, or for a group of UEs to which a sidelink communication is to be groupcast.

In some examples of the method, apparatuses, and non-transitory computer-readable medium described herein, the indication of IC capability received from each UE of the one or more other UEs indicates whether the UE of the one or more other UEs is capable of performing interference cancellation on received sidelink communications.

In some examples of the method, apparatuses, and non-transitory computer-readable medium described herein determining the IC capability for the sidelink communication comprises determining that IC capability is present when all of the one or more other UEs are capable of performing interference cancellation on received sidelink communications.

In some examples of the method, apparatuses, and non-transitory computer-readable medium described herein the indication of IC capability received from a UE of the one or more other UEs indicates a level of IC capability of the UE of the one or more other UEs.

In some examples of the method, apparatuses, and non-transitory computer-readable medium described herein the level of IC capability is a symbol level interference cancellation (SLIC) capability, or a codeword level IC capability.

In some examples of the method, apparatuses, and non-transitory computer-readable medium described herein determining the IC capability for the sidelink communication comprises determining a level of IC capability for the sidelink communication based on the level of IC capability of each of the one or more other UEs.

In some examples of the method, apparatuses, and non-transitory computer-readable medium described herein the sidelink communication is a unicast sidelink communication to be transmitted to one other UE, the indication of IC capability is received from the one other UE to which the unicast sidelink communication is to be transmitted and the determined IC capability for the unicast sidelink communication is determined based on the indication of IC capability received from the one other UE.

In some examples of the method, apparatuses, and non-transitory computer-readable medium described herein the sidelink communication is a groupcast sidelink communication to be transmitted to a plurality of other UEs, the indication of IC capability is received from each of the plurality of other UEs to which the groupcast sidelink communication is to be transmitted and the determined IC capability for the groupcast sidelink communication is determined based on the indications of IC capability received from the plurality of other UEs.

In some examples of the method, apparatuses, and non-transitory computer-readable medium described herein the sidelink communication is a broadcast sidelink communication to be transmitted to a plurality of other UEs and determining an IC capability for the sidelink communication comprises determining that IC capability is absent for the broadcast sidelink communication. For example, it may not be possible to obtain an indication of IC capability from every UE to which a broadcast sidelink communication is to be transmitted and since the plurality of UEs may include legacy UEs that do not support interference cancellation, IC capability may be reported as being absent so that the base station does not schedule the broadcast sidelink communication using an IC assumption.

In some examples of the method, apparatuses, and non-transitory computer-readable medium described herein the sidelink communication is a broadcast sidelink communication to be transmitted to a plurality of other UEs and determining an IC capability for the sidelink communication comprises determining a IC capability for the broadcast sidelink communication based on a sidelink application associated with the broadcast sidelink communication. For example, there may be sidelink applications which target new release or advanced UEs that may be IC capable by default and so, for sidelink communications associated with those sidelink applications, IC capability may be reported as being present.

In some examples of the method, apparatuses, and non-transitory computer-readable medium described herein the indication of allocated resources received from the base station includes an indication of an IC assumption for the allocated resources. For example, where the indication of the IC assumption indicates that IC is assumed by the base station in scheduling, the UE may determine that there is another overlapping transmission in a resource of the resources allocated for the sidelink communication.

Some examples of the method, apparatuses, and non-transitory computer-readable medium described herein may further include operations, features, means, or instructions for determining a modulation coding scheme (MCS) for the sidelink communication based on the IC assumption for the allocated resources and transmitting the sidelink communication to the one or more other UEs using the determined MCS. For example, if the indication of the IC assumption indicates that IC is assumed by the base station in scheduling, the UE may use a lower MCS index for the sidelink communication as interference may affect decoding at the one or more other UEs, even when the one or more other UEs are capable of performing interference cancellation.

Some examples of the method, apparatuses, and non-transitory computer-readable medium described herein may further include operations, features, means, or instructions for transmitting an indication of the IC assumption to the one or more other UEs. This allows the one or more other UEs to determine whether to perform interference cancellation based on whether an overlapping transmission is scheduled in a resource of the resources allocated to the sidelink communication. This may avoid a situation where the one or more other UEs perform interference cancellation by default, even where there is no overlapping transmission.

Some examples of the method, apparatuses, and non-transitory computer-readable medium described herein may further include operations, features, means, or instructions for receiving, from the base station, an indication of a demodulation reference signal (DMRS) index assigned to the sidelink communication and an indication of a DMRS index assigned to another sidelink communication to which overlapping resources have been allocated. The indication of the DMRS index assigned to the sidelink communication may be provided in a DCI message that provides the indication of resources allocated for the sidelink communication. The indication of the DMRS index assigned to the sidelink communication may be provided in a first field of the DCI message and the indication of the DMRS index assigned to another sidelink communication to which overlapping resources have been allocated may be provided in a second field of the DCI message.

Some examples of the method, apparatuses, and non-transitory computer-readable medium described herein may further include operations, features, means, or instructions for transmitting, to the one or more other UEs, the indication of the DMRS index assigned to the sidelink communication and the indication of the DMRS index assigned to the other sidelink communication to which overlapping resources have been allocated. This may allow the one or more other UEs to perform interference cancellation without blindly decoding overlapping transmissions.

According to an aspect, there is provided a method for wireless communication at a base station. The method comprises receiving, from a UE, a report of interference cancellation (IC) capability for a sidelink communication to be transmitted by the UE, allocating resources for the sidelink communication based on the reported IC capability, and transmitting, to the UE, an indication of the resources allocated for the sidelink communication.

According to an aspect, there is provided an apparatus for wireless communication at a base station. The apparatus comprises means for receiving, from a UE, a report of interference cancellation (IC) capability for a sidelink communication to be transmitted by the UE, means for allocating resources for the sidelink communication based on the reported IC capability, and means for transmitting, to the UE, an indication of the resources allocated for the sidelink communication.

According to an aspect, there is provided an apparatus for wireless communication at a base station. The apparatus comprises a memory and one or more processors operatively coupled to the memory, the memory and the one or more processors configured to receive, from a UE, a report of interference cancellation (IC) capability for a sidelink communication to be transmitted by the UE, allocate resources for the sidelink communication based on the reported IC capability, and transmit, to the UE, an indication of the resources allocated for the sidelink communication.

According to an aspect, there is provided a non-transitory computer-readable medium storing code for wireless communication at a base station. The code includes instructions executable by a processor to receive, from a UE, a report of interference cancellation (IC) capability for a sidelink communication to be transmitted by the UE, allocate resources for the sidelink communication based on the reported IC capability, and transmit, to the UE, an indication of the resources allocated for the sidelink communication.

In some examples of the method, apparatuses, and non-transitory computer-readable medium described herein the indication of allocated resources received from the base station includes an indication of an interference cancellation assumption for the allocated resources.

In some examples of the method, apparatuses, and non-transitory computer-readable medium described herein allocating resources for the sidelink communication comprises allocating resources that overlap at least in part with resources allocated to another sidelink communication when the reported IC capability indicates that IC capability is present for the sidelink communication.

In some examples of the method, apparatuses, and non-transitory computer-readable medium described herein the indication of the IC assumption indicates that interference cancellation is assumed. For example, where the allocated resources overlap at least in part with resources allocated to another sidelink communication, the indication of the IC assumption may indicate that interference cancellation is assumed. Where the allocated resources do not overlap with resources allocated to another sidelink communication, the indication of the IC assumption may indicate that interference cancellation is not assumed.

Some examples of the method, apparatuses, and non-transitory computer-readable medium described herein may further include operations, features, means, or instructions for assigning orthogonal demodulation reference signals (DMRS) to the sidelink communication and to another other sidelink communication to which overlapping resources are allocated. In existing NR sidelink, three orthogonal cover codes have been specified for PSCCH DMRS. The transmit UE randomly selects one for its sidelink communication. When two sidelink transmissions happen to take place in the same resource, the two transmissions may have orthogonal PSCCH DMRS if the transmit UEs have selected different cover codes, so a receive UE may be able to decode at least one transmission. For IC capable sidelink communication, the base station may assign orthogonal DMRS for PSCCH and/or PSSCH to overlapping transmissions in order to facilitate IC operation at the receive UE.

Some examples of the method, apparatuses, and non-transitory computer-readable medium described herein may further include operations, features, means, or instructions for transmitting, to the UE, an indication of the assigned DMRS index for the sidelink communication and an indication of the DMRS index assigned to the other sidelink communication.

According to an aspect, there is provided a method for wireless communication at a UE. The method comprises transmitting an indication of interference cancellation (IC) capability to another UE from which a sidelink communication is to be received and receiving the sidelink communication from the other UE using resources allocated to the other UE based at least in part on the IC capability. For example, the resources may be allocated based at least in part on the indication of the IC capability.

According to an aspect, there is provided an apparatus for wireless communication at a base station. The apparatus comprises means for transmitting an indication of interference cancellation (IC) capability to another UE from which a sidelink communication is to be received and means for receiving the sidelink communication from the other UE using resources allocated to the other UE based at least in part on the IC capability. For example, the resources may be allocated based at least in part on the indication of the IC capability.

According to an aspect, there is provided an apparatus for wireless communication at a base station. The apparatus comprises a memory and one or more processors operatively coupled to the memory, the memory and the one or more processors configured to transmit an indication of interference cancellation (IC) capability to another UE from which a sidelink communication is to be received and receive the sidelink communication from the other UE using resources allocated to the other UE based at least in part on the IC capability. For example, the resources may be allocated based at least in part on the indication of the IC capability.

According to an aspect, there is provided a non-transitory computer-readable medium storing code for wireless communication at a base station. The code includes instructions executable by a processor to transmit an indication of interference cancellation (IC) capability to another UE from which a sidelink communication is to be received and receive the sidelink communication from the other UE using resources allocated to the other UE based at least in part on the IC capability. For example, the resources may be allocated based at least in part on the indication of the IC capability.

Some examples of the method, apparatuses, and non-transitory computer-readable medium described herein may further include operations, features, means, or instructions for receiving, from the other UE, an indication of an IC assumption for the allocated resources.

Some examples of the method, apparatuses, and non-transitory computer-readable medium described herein may further include operations, features, means, or instructions for selectively performing interference cancellation on the received sidelink communication based on the indication of the IC assumption. For example, interference cancellation may be performed if the IC assumption indicates that interference cancellation is assumed. Alternatively, or additionally, interference cancellation may be selectively performed based on the IC capability. For example, where no indication of an IC assumption for the allocated resources is received from the other UE, an IC capable UE may perform interference cancellation by default.

Some examples of the method, apparatuses, and non-transitory computer-readable medium described herein may further include operations, features, means, or instructions for receiving, from the other UE, an indication of a DMRS index assigned to the sidelink communication and an indication of a DMRS index assigned to another other sidelink communication to which overlapping resources have been allocated.

Some examples of the method, apparatuses, and non-transitory computer-readable medium described herein may further include operations, features, means, or instructions for selectively performing interference cancellation on the received sidelink communication based on the indication of the DMRS indices.

### BRIEF DESCRIPTION OF THE DRAWINGS

FIG. 1 illustrates an example of a wireless communications system that supports techniques for interference cancellation capability awareness for sidelink communications.

FIG. 2 illustrates an example of a wireless communications system that supports techniques for interference cancellation capability awareness for sidelink communications, in accordance with aspects of the present disclosure.

FIG. 3 illustrates an example of a process flow that supports techniques for interference cancellation capability awareness for unicast and groupcast sidelink communications, in accordance with aspects of the present disclosure.

FIG. 4 illustrates an example of a process flow that supports techniques for interference cancellation capability awareness for broadcast sidelink communications, in accordance with aspects of the present disclosure.

FIG. 5 illustrates a device that supports techniques for interference cancellation capability awareness for sidelink communications in accordance with one or more aspects of the present disclosure.

FIG. 6 illustrates a device that supports techniques for interference cancellation capability awareness for sidelink communications in accordance with one or more aspects of the present disclosure.

FIG. 7 illustrates a device that supports techniques for interference cancellation capability awareness for sidelink communications in accordance with one or more aspects of the present disclosure.

FIGS. 8 to 10 show flowcharts illustrating methods that support techniques for interference cancellation capability awareness for sidelink communications in accordance with one or more aspects of the present disclosure.

### DETAILED DESCRIPTION

Aspects of the disclosure are initially described in the context of wireless communications systems. Additional aspects of the disclosure are described in the context of an example process flow. Aspects of the disclosure are further illustrated by and described with reference to apparatus diagrams and flowcharts that relate to techniques for interference cancellation capability awareness for sidelink communications.

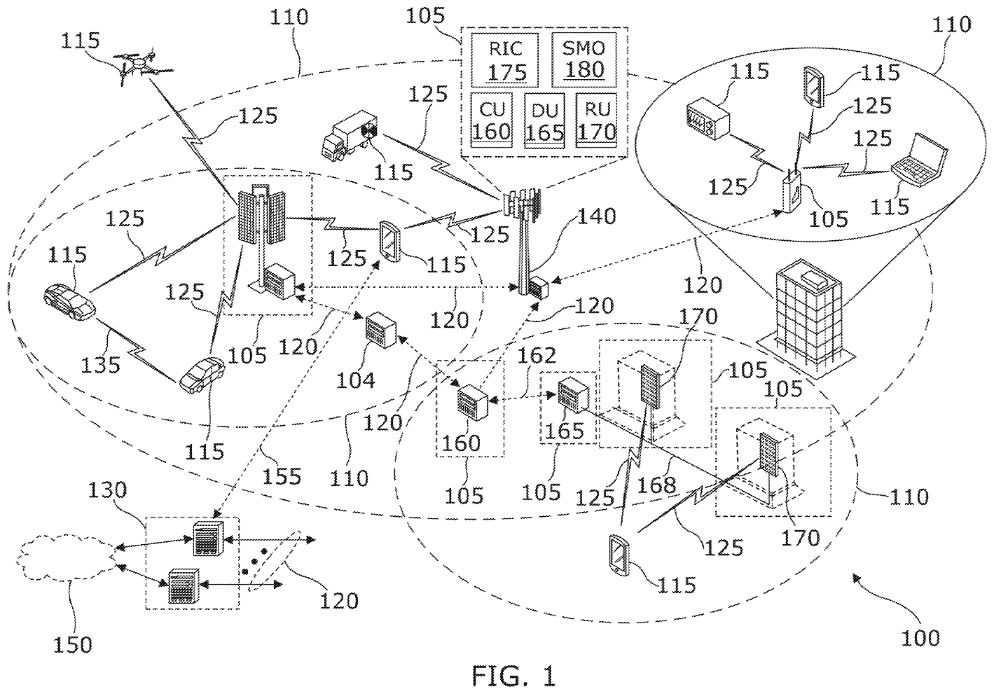

FIG. 1 illustrates an example of a wireless communications system 100 that supports techniques for interference cancellation capability awareness for sidelink communications in accordance with one or more aspects of the present disclosure. The wireless communications system 100 includes one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for energy transfer devices supporting multiple types of wireless energy as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, the wireless communications system 100 may support signaling procedures to enable IC aware sidelink scheduling, particularly Mode 1 scheduling, considering different case types, as well as facilitating receive UE operation, so that IC gains associated with advanced receivers having IC capability may be realized. For example, a transmit UE 115 of the wireless communication system 100 may determine an IC capability for a sidelink communication, wherein the sidelink communication is to be transmitted to one or more receive UEs 115 of the wireless communications system 100, and may report the determined IC capability for the sidelink communication to a network entity 105 (such as a base station 140). The IC capability for the sidelink communication may be determined by the transmit UE based on an indication received from the one or more receive UEs 115 to which the sidelink communication is to be transmitted, or may be determined by the transmit UE based on the cast type of the sidelink communication. The network entity 105 (or base station 140) may allocate resources for the sidelink communication based on the reported IC capability and transmit, to the transmit UE 115, an indication of the resources allocated for the sidelink communication. The transmit UE 115 may then transmit the sidelink communication to the one or more receive UEs 115 using the allocated resources. Providing the base station with an awareness of IC capability for the sidelink communication may allow IC gains associated with IC capability of advanced receivers to be realized, thereby increasing reliability of sidelink communications and improving network capacity.

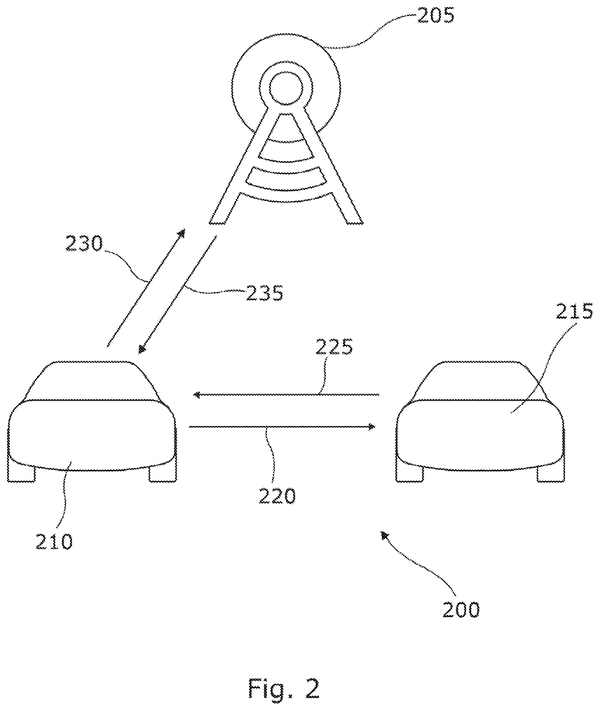

FIG. 2 illustrates an example of a wireless communications system 200 that supports techniques for interference cancellation capability awareness for sidelink communications in accordance with an aspect of the disclosure. In some examples, aspects of the wireless communications system 200 may implement, or be implemented by, aspects of the wireless communications system 100. In particular, the wireless communications system 200 may support signaling that enables wireless devices to exchange information regarding interference cancellation capability for sidelink communications, as described herein.

The wireless communications system 200 includes a base station or network entity 205, a transmit UE 210 and a receive UE 215. In other embodiments, the wireless communications system 200 may include a plurality of receive UEs 215. In FIG. 2, the transmit UE 210 and receive UE 215 are illustrated as vehicles. However, each of the transmit and receive UEs may be any type of user equipment, such as a cellular phone, a personal digital assistant (PDA), a tablet computer, a laptop computer, a personal computer, a wireless local loop (WLL) station, an Internet of Things (IoT) device, an Internet of Everything (IoE) device, or a machine type communications (MTC) device, among other examples.

In some aspects, transmit UE 210 and receive UE 215 may communicate directly using one or more sidelink channels (e.g., without using base station 205 as an intermediary to communicate with one another). For example, the UEs 210, 215 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. The sidelink channels may include one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

Accordingly, aspects of the present disclosure are directed to signaling procedures to enable IC aware sidelink scheduling, such as Mode 1 scheduling, considering different case types, as well as facilitating receive UE operation, so that IC gains associated with advanced receivers having IC capability may be realized. For example, a transmit UE may determine an IC capability for a sidelink communication, wherein the sidelink communication is to be transmitted to one or more receive UEs, and may report the determined IC capability for the sidelink communication to a base station. The IC capability for the sidelink communication may be determined by the transmit UE based on an indication received from the one or more receive UEs to which the sidelink communication is to be transmitted, or may be determined by the transmit UE based on the cast type of the sidelink communication. The base station may allocate resources for the sidelink communication based on the reported IC capability and transmit, to the transmit UE, an indication of the resources allocated for the sidelink communication. The transmit UE may then transmit the sidelink communication to the one or more receive UEs using the allocated resources. Providing the base station with an awareness of IC capability for the sidelink communication may allow IC gains associated with IC capability of advanced receivers to be realized, thereby increasing reliability of sidelink communications and improving network capacity.

For example, referring to the wireless communications system 200, the receive UE 215, transmit UE 210 and base station 205 may exchange IC capability information in order to utilize IC capability of the receive UE, where present, to increase network capacity. In the embodiment of the disclosure shown in FIG. 2, the sidelink communication 220 is illustrated as a unicast sidelink communication between transmit UE 210 and receive UE 215. In other embodiments, the sidelink communication may be groupcast or broadcast sidelink communication to be transmitted to a plurality of receive UEs.

The receive UE 215 may transmit an indication 225 of IC capability to the transmit UE 210 from which a sidelink communication 220 is to be received. For a unicast sidelink communication, the indication of IC capability may be provided in RRC signaling, for example, where a PC5-RRC connection is already established between the transmit UE 210 and the receive UE 215. The transmit UE 210 determines an IC capability for the sidelink communication 220 and transmits a report 230 of the determined IC capability for the sidelink communication to the base station 205. For a unicast sidelink communication as shown in FIG. 2, the transmit UE 210 may determine that IC capability for the unicast sidelink communication is present when receive UE 215 is capable of performing interference cancellation on received sidelink communications, as indicated by indication 225. If indication 225 indicates that receive UE 215 is not capable of performing interference cancellation, or if the indication 225 is not received by the transmit UE 210, the transmit UE may determine that IC capability for the sidelink communication 220 is absent.

The base station 205 receives the report 230 of the determined IC capability and allocates resources for the sidelink communication 220 based on the reported IC capability. The base station then transmits a resource grant 235 to the transmit UE 210, which provides an indication of the resources allocated for the sidelink communication 220.

The transmit UE 210 receives the resource grant 235, including the indication of resources allocated for the sidelink communication 220 and transmits the sidelink communication 220 to the receive UE using the allocated resources.

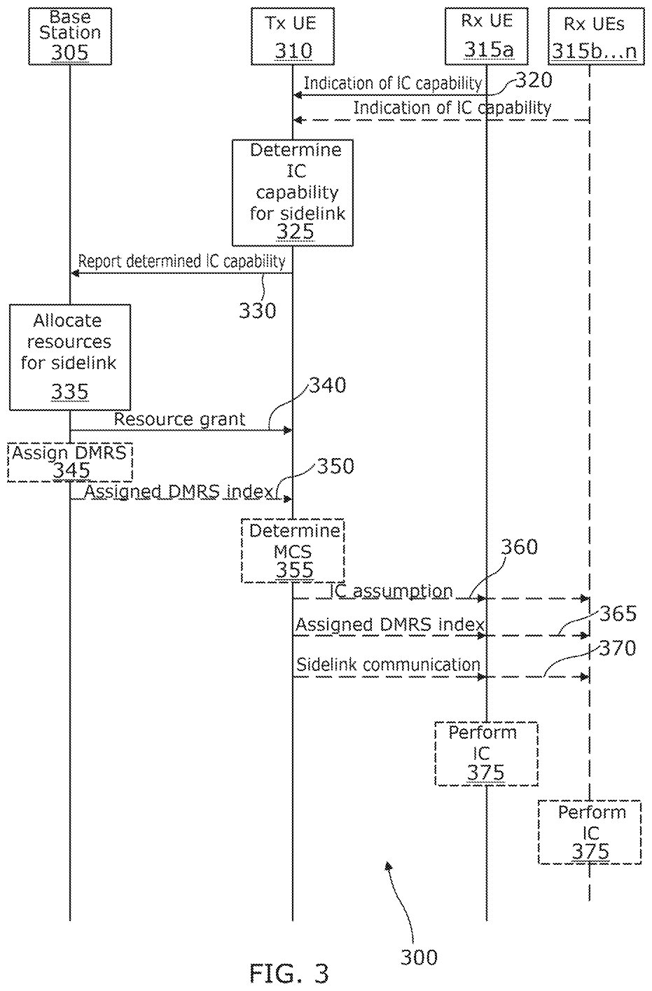

FIG. 3 illustrates an example of a process flow 300 that supports techniques for interference cancellation capability awareness for unicast or groupcast sidelink communications in accordance with an aspect of the disclosure. In some examples, aspects of the process flow 300 may implement, or be implemented by aspects of the wireless communications system 100 or wireless communications system 200. In particular, the process flow 300 illustrates signaling procedures to enable interference cancellation aware Mode 1 sidelink scheduling.

The process flow 300 includes a base station 305, a transmit UE 310, from which a sidelink communication is to be transmitted, and one or more receive UEs 315, to which a sidelink communication is to be transmitted. The base station 305, transmit UE 310 and receive UEs 315 may be examples of UEs 115, network entities 105, and other wireless devices described with reference to FIGS. 1 and 2. For example, the base station 305, the transmit UE 310 and the one or more receive UEs illustrated in FIG. 3 may be examples of the base station 205, the transmit UE 210 and the one or more receive UEs 215, respectively, as shown and described in FIG. 2.

In some examples, the operations illustrated in process flow 300 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 320, an indication of IC capability is transmitted from the one or more receive UEs 315 to the transmit UE 310. Where the sidelink communication is a unicast sidelink communication to be transmitted to one receive UE 315a, the indication of IC capability is transmitted from the receive UE 315a to the transmit UE 310. For a unicast sidelink communication, the indication of IC capability may be provided in RRC signaling. Where the sidelink communication is a groupcast sidelink communication to be transmitted to a plurality of receive UEs 315a, 315b . . . 315n, the indication of IC capability is transmitted from each of the plurality of receive UEs 315a, 315b . . . 315n to the transmit UE 310. For a groupcast sidelink communication, the indication of IC capability may be provided in RRC signaling (where an RRC connection is established between the receive UE and the transmit UE) or via a MAC control element (CE). The indication 320 of IC capability received from the or each receive UE 315 may indicate whether the receive UE is capable of performing interference cancellation on received sidelink communications. The indication of IC capability received from the or each receive UE 315 may indicate a level of IC capability of the receive UE 315. The level of IC capability may be a symbol level IC (SLIC) capability, or a codeword level IC capability.

At 325, the transmit UE 310 determines an IC capability for the sidelink communication. Determining the IC capability for the sidelink communication may comprise determining the IC capability for the sidelink communication based on the one or more indications received at 320. Determining the IC capability for the sidelink communication may comprise determining that IC capability is present when all of the receive UEs 315 are capable of performing interference cancellation on received sidelink communications. Where an indication of IC capability is not available or not received from the one or more receive UEs 315, the transmit UE 310 may determine that IC capability is absent for the sidelink communication.

For example, where the sidelink communication is a unicast sidelink communication to be transmitted to one receive UE 315a, the transmit UE 310 may determine that IC capability for the unicast sidelink communication is present when receive UE 315a is capable of performing interference cancellation on received sidelink communication, as indicated at 320. Where the receive UE 315a is not capable of performing interference cancellation on received sidelink communications, as indicated at 320, the transmit UE 310 may determine that IC capability for the unicast sidelink communication is absent. Where the indication of IC capability received from the receive UE 315a indicates that the receive UE 315a is capable of codeword level interference cancellation, the transmit UE 310 may determine that a level of IC capability for the sidelink communication is codeword level interference cancellation. Where the indication of IC capability received from the receive UE 315a indicates that the receive UE 315a is capable of symbol level interference cancellation, the transmit UE 310 may determine that a level of IC capability for the sidelink communication is symbol level interference cancellation.

In another example, where the sidelink communication is a groupcast sidelink communication to be transmitted to a plurality of receive UEs 315a, 315b . . . 315n, the transmit UE 310 may determine that IC capability for the groupcast sidelink communication is present when all of receive UEs 315a, 315b . . . 315n are capable of performing interference cancellation on received sidelink communications, as indicated at 320. Where one or more of the receive UEs 315a, 315b . . . 315n is not capable of performing interference cancellation on received sidelink communications, as indicated at 320, the transmit UE 310 may determine that IC capability for the groupcast sidelink communication is absent. Where the indication of IC capability received from the receive UEs 315a, 315b . . . 315n indicates that all of the receive UEs 315a, 315b . . . 315n are capable of codeword level interference cancellation, the transmit UE 310 may determine that a level of IC capability for the sidelink communication is codeword level interference cancellation. Where the indication of IC capability received from the receive UEs 315a, 315b . . . 315n indicates that at least one of the receive UEs 315a, 315b . . . 315n is capable of symbol level interference cancellation, the transmit UE 310 may determine that a level of IC capability for the sidelink communication is symbol level interference cancellation.

At 330, the transmit UE 310 reports the determined IC capability for the sidelink communication to the base station 305. The report may include an indication of the level of IC capability for the sidelink communication. The determined IC capability may be reported to the base station in a sidelink buffer status report. For example, a field may be provided in a sidelink buffer status report sent by the transmit UE 310 to the base station 305, which indicates whether IC capability is present for the sidelink communication and, optionally, the level of IC capability that can be performed (e.g. codeword level, symbol level). Alternatively, the determined IC capability may be reported using a dedicated MAC CE. A new MAC CE may be introduced to indicate whether IC capability is present for the sidelink communication and, optionally, the level of IC capability that can be performed (e.g. codeword level, symbol level). To achieve this a new logical channel ID may be assigned to the MAC CE indicating IC capability.

At 335, the base station 305 allocates resources for the sidelink communication based on the reported IC capability. When the reported IC capability indicates that IC capability is present for the sidelink communication, allocating resources for the sidelink communication may include allocating resources that overlap at least in part with resources allocated to another sidelink communication.

At 340, the base station 305 transmits, to the transmit UE 310, a resource grant which includes an indication of the resources allocated for the sidelink communication. The indication of allocated resources may include an indication of an interference cancellation assumption for the allocated resources. The indication of the interference cancellation assumption may be indicated using a field in DCI sent from the base station 305 to the transmit UE 310. Where the resources allocated for the sidelink communication include resources that overlap at least in part with resources allocated to another sidelink communication, the indication of the interference assumption may indicate that interference cancellation is assumed.

At 345, the base station 305 may optionally assign orthogonal demodulation reference signals (DMRS) to the sidelink communication and to another sidelink communication to which overlapping resources are allocated.

At 350, the base station 305 may optionally transmit, to the transmit UE 310, an indication of the assigned DMRS index for the sidelink communication and an indication of the DMRS index assigned to the other sidelink communication. The indication may indicate the index of the selected DMRS orthogonal cover code and the cyclic shift assigned to the sidelink communication and to the other sidelink communication to which overlapping resources are allocated. The indication may be included in a DCI message scheduling the sidelink communication. For example, the indication of the index of the DMRS orthogonal cover code assigned to the sidelink communication may be provided in a first field of the DCI message and the indication of the DMRS index assigned to another sidelink communication to which overlapping resources have been allocated may be provided in a second field of the DCI message.

At 355, the transmit UE 310 may optionally determine a modulation coding scheme (MCS) for the sidelink communication based on the interference assumption for the allocated resources.

At 360, the transmit UE 310 may optionally transmit an indication of the IC assumption to the receive UEs 315. The indication of the interference cancellation assumption may be indicated using a field in sidelink communication information (SCI) sent from the transmit UE 310 to the one or more receive UEs 315.

At 365, the transmit UE 310 may optionally transmit, to the one or more receive UEs 315, the indication of the DMRS index assigned to the sidelink communication and the indication of the DMRS index assigned to the other sidelink communication to which overlapping resources have been allocated.

At 370, the transmit UE 310 transmits the sidelink communication to the one or more receive UEs 315 using the allocated resources. Where the sidelink communication is a unicast sidelink communication, the transmit UE 310 transmits the unicast sidelink communication to the receive UE 315a. Where the sidelink communication is a groupcast sidelink communication, the transmit UE 310 transmits the groupcast sidelink communication to receive UEs 315a, 315b . . . 315n. Optionally, the transmit UE 310 may transmit the sidelink communication to the receive UEs 315 using the determined MCS.

At 375, the receive UEs 315 may optionally selectively perform interference cancellation on the received sidelink communication based on the indication of the IC assumption received from the transmit UE 310. For example, the indication of the IC assumption may be received in SCI as set out above. Typically, SCI is transmitted using a lower MCS than the sidelink communication itself so that it is more robust. This allows the one or more receive UEs 315 to decode the SCI in a regular manner and then, based on the indication, determine whether to perform interference cancellation for data channel decoding. The receive UEs 315 may selectively perform interference cancellation on the received sidelink communication based on the indication of the DMRS indices optionally received from the transmit UE 310.

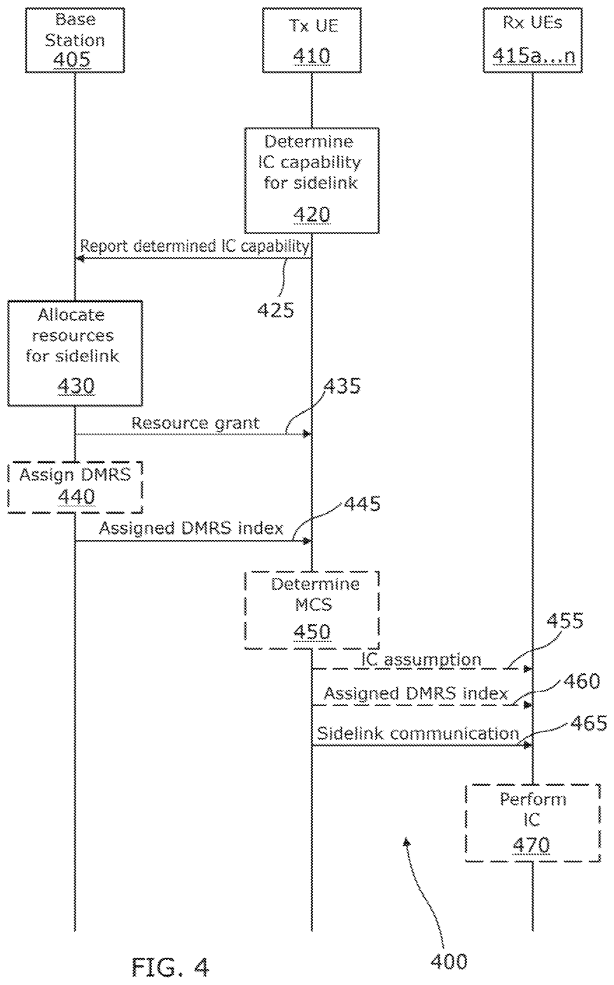

FIG. 4 illustrates an example of a process flow 400 that supports techniques for interference cancellation capability awareness for broadcast sidelink communications in accordance with an aspect of the disclosure. In some examples, aspects of the process flow 400 may implement, or be implemented by aspects of the wireless communications system 100 or wireless communications system 200. In particular, the process flow 400 illustrates signaling procedures to enable interference cancellation aware Mode 1 sidelink scheduling.

The process flow 400 includes a base station 405, a transmit UE 410, from which a sidelink communication is to be transmitted, and a plurality of receive UEs 415a . . . 415n, to which a broadcast sidelink communication is to be transmitted. The base station 405, transmit UE 410 and receive UEs 415 may be examples of UEs 115, network entities 105, and other wireless devices described with reference to FIGS. 1 and 2. For example, the base station 405, the transmit UE 410 and the plurality of receive UEs 415a . . . 415n illustrated in FIG. 4 may be examples of the base station 205, the transmit UE 210 and the one or more receive UEs 215, respectively, as shown and described in FIG. 2.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 420, the transmit UE 410 determines an IC capability for the broadcast sidelink communication. For a broadcast sidelink communication, it may niot be possible to obtain an indication of IC capability from each of the receive UEs 415 to which the broadcast sidelink communication is to be transmitted. For this reason, determining the IC capability for the broadcast sidelink communication may comprise determining that IC capability is absent for the broadcast sidelink communication. Alternatively, the IC capability for the broadcast sidelink communication may be determined based on a sidelink application associated with the broadcast sidelink communication. For example, there may be sidelink applications which target new release UEs that may be IC capable by default. If the broadcast sidelink communication is associated with such a sidelink application, the transmit UE 410 may determine that IC capability is present.

At 425, the transmit UE 410 reports the determined IC capability for the broadcast sidelink communication to the base station 405. The determined IC capability may be reported to the base station in a sidelink buffer status report. For example, an additional field may be provided in a sidelink buffer status report sent by the transmit UE 410 to the base station 405, which indicates whether IC capability is present for the sidelink communication and, optionally, the level of IC capability that can be performed (e.g. codeword level, symbol level). Alternatively, the determined IC capability may be reported using a dedicated MAC CE. A new MAC CE may be introduced to indicate whether IC capability is present for the sidelink communication and, optionally, the level of IC capability that can be performed (e.g. codeword level, symbol level). To achieve this a new logical channel ID may be assigned to the MAC CE indicating IC capability.

At 430, the base station 405 allocates resources for the broadcast sidelink communication based on the reported IC capability. When the reported IC capability indicates that IC capability is present for the sidelink communication, allocating resources for the sidelink communication may include allocating resources that overlap at least in part with resources allocated to another sidelink communication.

At 435, the base station 405 transmits, to the transmit UE 410, a resource grant which includes an indication of the resources allocated for the broadcast sidelink communication. The indication of allocated resources may include an indication of an interference cancellation assumption for the allocated resources. The indication of the interference cancellation assumption may be indicated using a field in DCI sent from the base station 405 to the transmit UE 410. Where the resources allocated for the sidelink communication include resources that overlap at least in part with resources allocated to another sidelink communication, the indication of the interference assumption may indicate that interference cancellation is assumed.

At 440, the base station 405 may optionally assign orthogonal demodulation reference signals (DMRS) to the sidelink communication and to another sidelink communication to which overlapping resources are allocated.

At 445, the base station 405 may optionally transmit, to the transmit UE 410, an indication of the assigned DMRS index for the sidelink communication and an indication of the DMRS index assigned to the other sidelink communication. The indication may indicate the index of the selected DMRS orthogonal cover code and the cyclic shift assigned to the sidelink communication and to the other sidelink communication to which overlapping resources are allocated. The indication may be included in a DCI message scheduling the sidelink communication. For example, the indication of the index of the DMRS orthogonal cover code assigned to the sidelink communication may be provided in a first field of the DCI message and the indication of the DMRS index assigned to another sidelink communication to which overlapping resources have been allocated may be provided in a second field of the DCI message.

At 450, the transmit UE 410 may optionally determine a modulation coding scheme (MCS) for the sidelink communication based on the interference assumption for the allocated resources.

At 455, the transmit UE 410 may optionally transmit an indication of the IC assumption to the plurality of receive UEs 415. The indication of the interference cancellation assumption may be indicated using a field in SCI sent from the transmit UE 410 to the receive UEs 415.

At 460, the transmit UE 410 may optionally transmit, to the plurality of receive UEs 415, the indication of the DMRS index assigned to the sidelink communication and the indication of the DMRS index assigned to the other sidelink communication to which overlapping resources have been allocated.

At 465, the transmit UE 410 transmits the broadcast sidelink communication to the plurality of receive UEs 415 using the allocated resources. Optionally, the transmit UE 410 may transmit the sidelink communication to the receive UEs 415 using the determined MCS.

At 470, the receive UEs 415 may optionally selectively perform interference cancellation on the received sidelink communication based on the indication of the IC assumption received from the transmit UE 410. For example, the indication of the IC assumption may be received in SCI as set out above. Typically, SCI is transmitted using a lower MCS than the sidelink communication itself so that it is more robust. This allows the receive UEs 415 to decode the SCI in a regular manner and then, based on the indication, determine whether to perform interference cancellation for data channel decoding. The receive UEs 415 may selectively perform interference cancellation on the received sidelink communication based on the indication of the DMRS indices optionally received from the transmit UE 410.

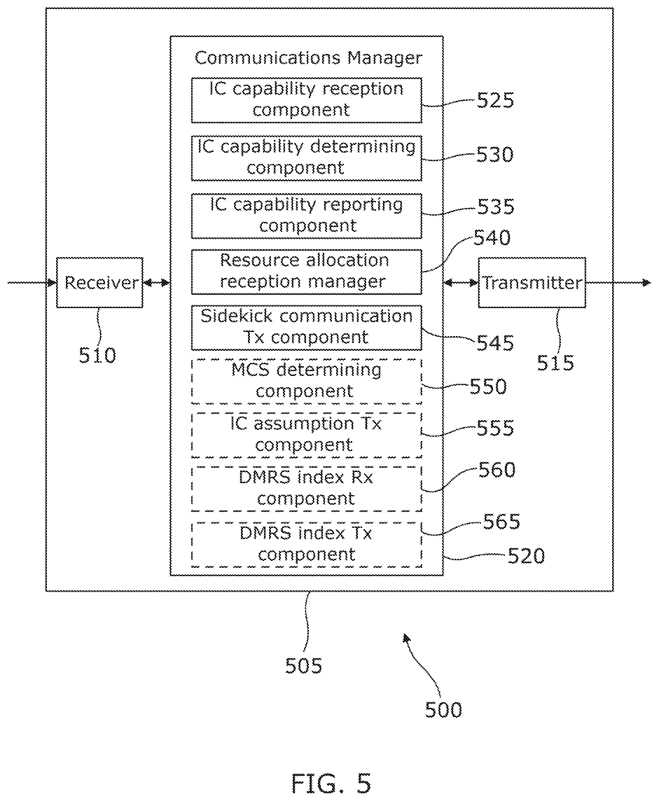

FIG. 5 shows a diagram 500 of a device 505 that supports techniques for interference cancellation capability awareness for sidelink communications in accordance with aspects of the disclosure. The device 505 may be an example of aspects of a transmit UE 310 or transmit UE 410 or a UE 115 as described herein. The device 505 includes a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, and information channels related to techniques for interference cancellation capability awareness for sidelink communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for interference cancellation capability awareness for sidelink communications). In some examples, the transmitter 515 may be co-located with a receiver 510 in a transceiver module. The transmitter 515 may utilize a single antenna or a set of multiple antennas.

The device, or various components thereof, may be an example of means for performing various aspects of techniques for interference cancellation capability awareness for sidelink communications as described herein. In the embodiment of FIG. 5, the communications manager 520 includes an IC capability determining component 530, an IC capability reporting component 535, a resource allocation reception component 540, a sidelink communication transmission component 545, and optionally, an IC capability reception component 525, an MCS determining component 550, an IC assumption transmission component 555, a DMRS index reception component 560 and a DMRS index transmission component 565. In some examples, the communications manager 520, or various components thereof, may be configured to perform various operations (e.g., determining, reporting, receiving, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a transmit UE in accordance with examples as disclosed herein. The IC capability reception component 525 may be configured as or otherwise support a means for receiving an indication of interference cancellation capability from each of one or more receive UEs to which the sidelink communication is to be transmitted. The IC capability determining component 530 may be configured as or otherwise support a means for determining an IC capability for a sidelink communication, wherein the sidelink communication is to be transmitted to one or more receive UEs. The IC capability reporting component 535 may be configured as or otherwise support a means for reporting the determined IC capability for the sidelink communication to a base station. The resource allocation reception component 540 may be configured as or otherwise support a means for receiving, from the base station, an indication of resources allocated for the sidelink communication based on the reported IC capability. The sidelink communication transmission component 545 may be configured as or otherwise support a means for transmitting the sidelink communication to the one or more receive UEs using the allocated resources. The MCS determining component 550 may be configured as or otherwise support a means for determining a modulation coding scheme for the sidelink communication based on an IC assumption for the allocated resources. The IC assumption transmission component 555 may be configured as or otherwise support a means for transmitting an indication of the IC assumption to the one or more receive UEs. The DMRS index reception component 560 may be configured as or otherwise support a means for receiving, from the base station, an indication of a demodulation reference signal, DMRS, index assigned to the sidelink communication and an indication of a DMRS index assigned to another sidelink communication to which overlapping resources have been allocated. The DMRS index transmission component 565 may be configured as or otherwise support a means for transmitting, to the one or more receive UEs, the indication of the demodulation reference signal, DMRS, index assigned to the sidelink communication and the indication of a DMRS index assigned to the other sidelink communication to which overlapping resources have been allocated.

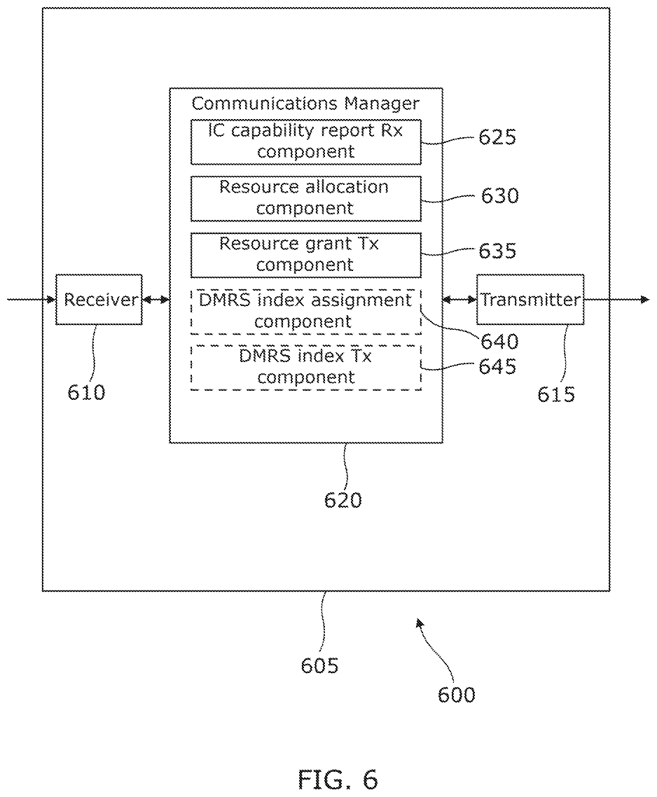

FIG. 6 shows a diagram 600 of a device 605 that supports techniques for interference cancellation capability awareness for sidelink communications in accordance with aspects of the disclosure. The device 605 may be an example of aspects of a base station 305 or base station 405 or a network entity 105 as described herein. The device 605 includes a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, and information channels related to techniques for interference cancellation capability awareness for sidelink communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for interference cancellation capability for sidelink communications). In some examples, the transmitter 615 may be co-located with a receiver 610 in a transceiver module. The transmitter 615 may utilize a single antenna or a set of multiple antennas.

The device, or various components thereof, may be an example of means for performing various aspects of techniques for interference cancellation awareness for sidelink communications as described herein. In the embodiment of FIG. 6, the communications manager 620 includes an IC capability report reception component 625, a resource allocation component 630, a resource grant transmission component 635, and optionally, a DMRS index assignment component 640 and a DMRS index transmission component 645. In some examples, the communications manager 620, or various components thereof, may be configured to perform various operations (e.g., determining, reporting, receiving, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a base station in accordance with examples as disclosed herein. The IC capability report reception component 625 may be configured as or otherwise support a means for receiving, from a UE, a report of IC capability for a sidelink communication to be transmitted by the UE. The resource allocation component 630 may be configured as or otherwise support a means for allocating resources for the sidelink communication based on the reported IC capability. The resource grant transmission component 635 may be configured as or otherwise support a means for transmitting, to the UE, an indication of the resources allocated for the sidelink communication. The DMRS index assignment component 640 may be configured as or otherwise support a means for assigning orthogonal DMRS to the sidelink communication and to the other sidelink communication to which overlapping resources are allocated. The DMRS index transmission component 645 may be configured as or otherwise support a means for transmitting, to the UE, an indication of the assigned DMRS index for the sidelink communication and an indication of the DMRS index assigned to the other sidelink communication.

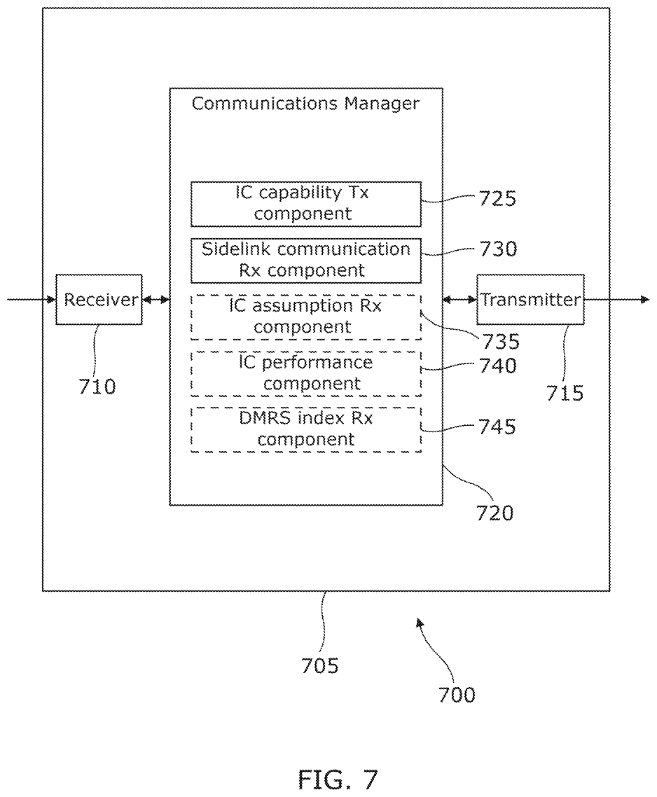

FIG. 7 shows a diagram 700 of a device 705 that supports techniques for interference cancellation capability awareness for sidelink communications in accordance with aspects of the disclosure. The device 705 may be an example of aspects of a receive UE 315 or receive UE 415 or a UE 115 as described herein. The device 705 includes a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, and information channels related to techniques for interference cancellation capability awareness for sidelink communications). Information may be passed on to other components of the device 705. The receiver 510 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for interference cancellation capability awareness for sidelink communications). In some examples, the transmitter 715 may be co-located with a receiver 710 in a transceiver module. The transmitter 715 may utilize a single antenna or a set of multiple antennas.

The device, or various components thereof, may be an example of means for performing various aspects of techniques for interference cancellation capability awareness for sidelink communications as described herein. In the embodiment of FIG. 7, the communications manager 720 includes an IC capability transmission component 725, a sidelink communication reception component 730, and optionally, an IC assumption reception component 735, an IC performance component 740, and a DMRS index reception component 745. In some examples, the communications manager 720, or various components thereof, may be configured to perform various operations (e.g., determining, reporting, receiving, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a receive UE in accordance with examples as disclosed herein. The IC capability transmission component 725 may be configured as or otherwise support a means for transmitting an indication of IC capability to a transmit UE from which a sidelink communication is to be received. The sidelink communication reception component 730 may be configured as or otherwise support a means for receiving the sidelink communication from the transmit UE using resources allocated to the transmit UE based at least in part on the indication of IC capability. The IC assumption reception component 735 may be configured as or otherwise support a means for receiving, from the transmit UE, an indication of an IC assumption for the allocated resources. The IC performance component 740 may be configured as or otherwise support a means for selectively performing interference cancellation on the received sidelink communication based on the indication of the IC assumption. The DMRS index reception component 745 may be configured as or otherwise support a means for receiving, from the transmit UE, an indication of a DMRS index assigned to the sidelink communication and an indication of a DMRS index assigned to another other sidelink communication to which overlapping resources have been allocated. The IC performance component 740 may be configured as or otherwise support a means for selectively performing interference cancellation on the received sidelink communication based on the indication of the DMRS indices.

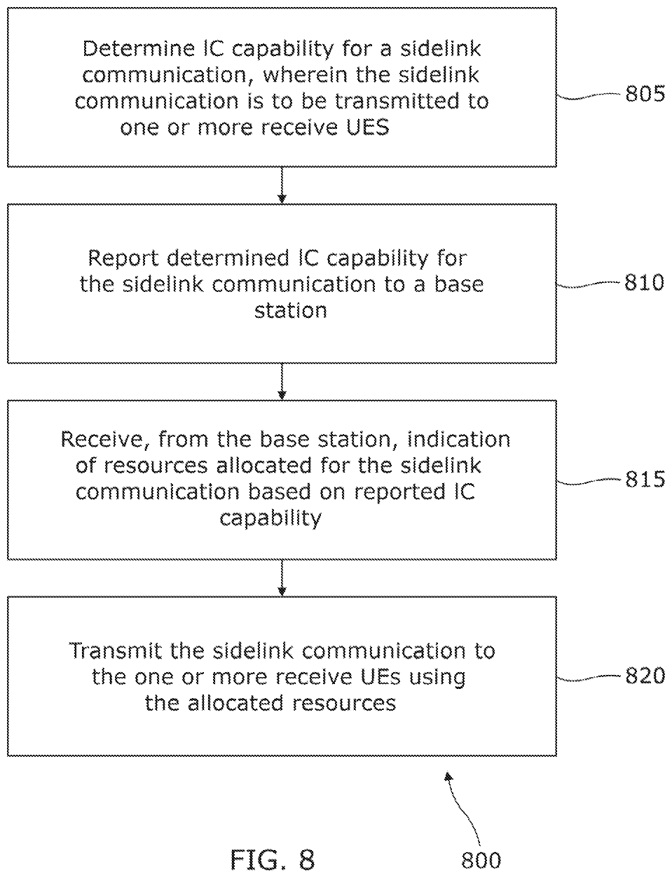

FIG. 8 shows a flowchart illustrating a method 800 that supports techniques for interference cancellation capability awareness for sidelink communications in accordance with aspects of the disclosure. The operations of the method 800 may be implemented by a transmit UE or its components as described herein. For example, the operations of the method 800 may be performed by a UE 115 as described with reference to FIGS. 1 and 5. In some examples, a UE may execute a set of instructions to control the functional elements of the UE to perform the described functions. Additionally, or alternatively, the UE may perform aspects of the described functions using special-purpose hardware.

At 805, the method includes determining an IC capability for a sidelink communication, wherein the sidelink communication is to be transmitted to one or more receive UEs. The operations of 805 may be performed in accordance with examples as disclosed herein. In some examples, aspects of the operations of 805 may be performed by an IC capability determination component 530 as described with reference to FIG. 5.

At 810, the method includes reporting the determined IC capability for the sidelink communication to a base station. The operations of 810 may be performed in accordance with examples as disclosed herein. In some examples, aspects of the operations of 810 may be performed by an IC capability reporting component 535 as described with reference to FIG. 5.

At 815, the method includes receiving, from the base station, an indication of resources allocated for the sidelink communication based on the reported IC capability. The operations of 815 may be performed in accordance with examples as disclosed herein. In some examples, aspects of the operations of 815 may be performed by a resource allocation reception component 540 as described with reference to FIG. 5.

At 820, the method includes transmitting the sidelink communication to the one or more other UEs using the allocated resources. The operations of 820 may be performed in accordance with examples as disclosed herein. In some examples, aspects of the operations of 820 may be performed by a sidelink communication transmission component 545 as described with reference to FIG. 5.

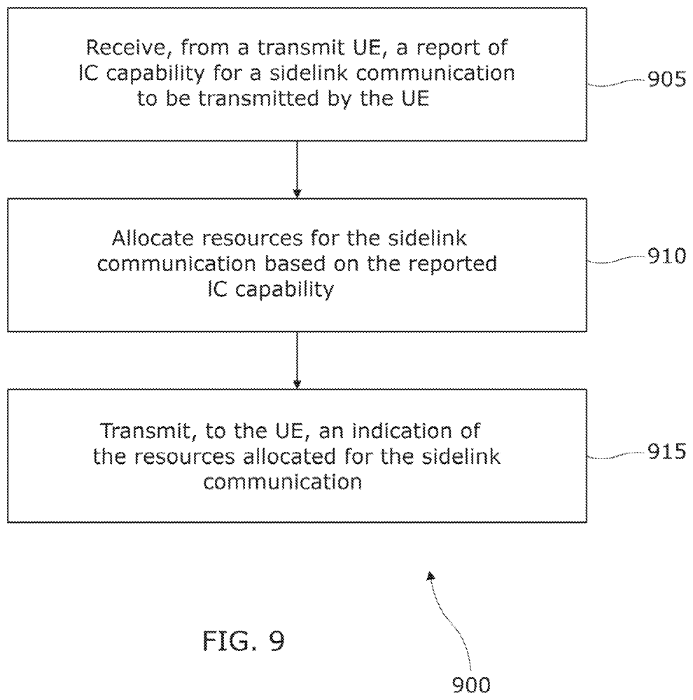

FIG. 9 shows a flowchart illustrating a method 900 that supports techniques for interference cancellation capability awareness for sidelink communications in accordance with aspects of the disclosure. The operations of the method 900 may be implemented by a base station or its components as described herein. For example, the operations of the method 900 may be performed by a network entity 105 or base station as described with reference to FIGS. 1 and 6. In some examples, a base station may execute a set of instructions to control the functional elements of the base station to perform the described functions. Additionally, or alternatively, the base station may perform aspects of the described functions using special-purpose hardware.

At 905, the method includes receiving, from a transmit UE, a report of IC capability for a sidelink communication to be transmitted by the UE. The operations of 905 may be performed in accordance with examples as disclosed herein. In some examples, aspects of the operations of 905 may be performed by an IC capability report reception component 625 as described with reference to FIG. 6.

At 910, the method includes allocating resources for the sidelink communication based on the reported IC capability. The operations of 910 may be performed in accordance with examples as disclosed herein. In some examples, aspects of the operations of 910 may be performed by resource allocation component 630 as described with reference to FIG. 6.

At 915, the method includes transmitting, to the UE, an indication of the resources allocated for the sidelink communication. The operations of 915 may be performed in accordance with examples as disclosed herein. In some examples, aspects of the operations of 915 may be performed by resource grant transmission component 635 as described with reference to FIG. 6.

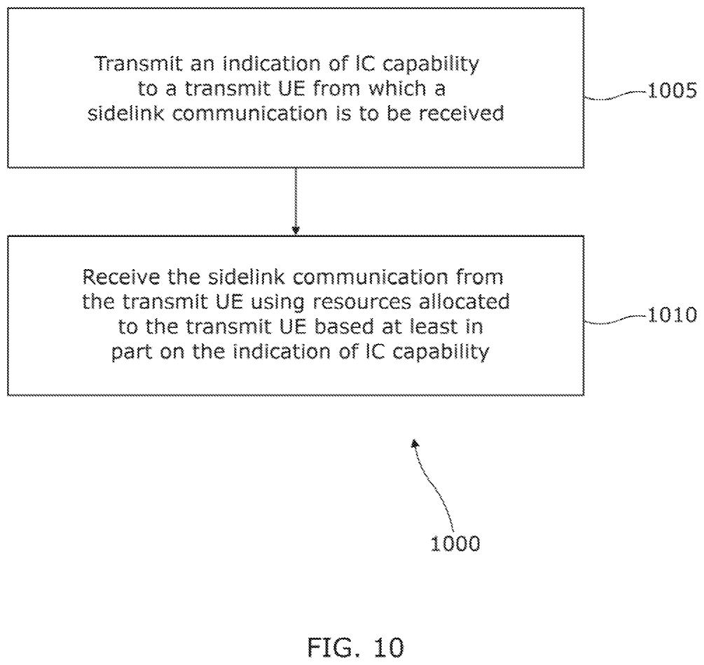

FIG. 10 shows a flowchart illustrating a method 1000 that supports techniques for interference cancellation capability awareness for sidelink communications in accordance with aspects of the disclosure. The operations of the method 800 may be implemented by a receive UE or its components as described herein. For example, the operations of the method 1000 may be performed by a UE 115 as described with reference to FIGS. 1 and 7. In some examples, a UE may execute a set of instructions to control the functional elements of the UE to perform the described functions. Additionally, or alternatively, the UE may perform aspects of the described functions using special-purpose hardware.

At 1005, the method includes transmitting an indication of IC capability to a transmit UE from which a sidelink communication is to be received. The operations of 1005 may be performed in accordance with examples as disclosed herein. In some examples, aspects of the operations of 1005 may be performed by IC capability transmission component 725 as described with reference to FIG. 7.

At 1010, the method includes receiving the sidelink communication from the transmit UE using resources allocated to the transmit UE based at least in part on the indication of IC capability. The operations of 1010 may be performed in accordance with examples as disclosed herein. In some examples, aspects of the operations of 1010 may be performed by sidelink communication reception component 730 as described with reference to FIG. 7.

Certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 8, FIG. 9, and/or FIG. 10.

The following provides an overview of some aspects of the present disclosure.

Aspect 1 is a method for wireless communication at a UE. The method comprises determining an interference cancellation, IC, capability for a sidelink communication, wherein the sidelink communication is to be transmitted to one or more other UEs. The method includes reporting the determined IC capability for the sidelink communication to a base station. The method also includes receiving, from the base station, an indication of resources allocated for the sidelink communication based on the reported IC capability. The method further includes transmitting the sidelink communication to the one or more other UEs using the allocated resources.

In Aspect 2, the method of Aspect 1 further includes receiving an indication of IC capability from each of the one or more other UEs to which the sidelink communication is to be transmitted, wherein determining the IC capability for the sidelink communication comprises determining the IC capability for the sidelink communication based on the one or more received indications.

In Aspect 3, the indication of IC capability received from each UE of the one or more other UEs, in Aspect 2, indicates whether the UE of the one or more other UEs is capable of performing interference cancellation on received sidelink communications.

In Aspect 4, determining the IC capability for the sidelink communication, in any of Aspects 2 or 3, comprises determining that IC capability is present when all of the one or more other UEs are capable of performing interference cancellation on received sidelink communications.

In Aspect 5, the indication of IC capability received from a UE of the one or more other UEs, in any of Aspects 2 to 4, indicates a level of IC capability of the UE of the one or more other UEs.

In Aspect 6, the level of IC capability of Aspect 5 is a symbol level interference cancellation, SLIC, capability, or a codeword level IC capability.

In Aspect 7, determining the IC capability for the sidelink communication, in Aspect 5 or Aspect 6, comprises determining a level of IC capability for the sidelink communication based on the level of IC capability of each of the one or more other UEs.

Aspect 8 relates to a method according to any of Aspects 2 to 7, wherein the sidelink communication is a unicast sidelink communication to be transmitted to one other UE, the indication of IC capability is received from the one other UE to which the unicast sidelink communication is to be transmitted, and the determined IC capability for the unicast sidelink communication is determined based on the indication of IC capability received from the one other UE.

Aspect 9 relates to a method according to any of Aspects 2 to 7, wherein the sidelink communication is a groupcast sidelink communication to be transmitted to a plurality of other UEs, the indication of IC capability is received from each of the plurality of other UEs to which the groupcast sidelink communication is to be transmitted, and the determined IC capability for the groupcast sidelink communication is determined based on the indications of IC capability received from the plurality of other UEs.

Aspect 10 relates to a method according to Aspect 1, wherein the sidelink communication is a broadcast sidelink communication to be transmitted to a plurality of other UEs, and determining an IC capability for the sidelink communication comprises determining that IC capability is absent for the broadcast sidelink communication.

Aspect 11 relates to a method according to Aspect 1, wherein the sidelink communication is a broadcast sidelink communication to be transmitted to a plurality of other UEs, and determining an IC capability for the sidelink communication comprises determining a IC capability for the broadcast sidelink communication based on a sidelink application associated with the broadcast sidelink communication.

In Aspect 12, the indication of allocated resources received from the base station, in ay of Aspects 1 to 11, includes an indication of an IC assumption for the allocated resources.

In Aspect 13, the method of Aspect 12 further comprises determining a modulation coding scheme, MCS, for the sidelink communication based on the IC assumption for the allocated resources, and transmitting the sidelink communication to the one or more other UEs using the determined MCS.

In Aspect 14, the method of Aspect 12 or Aspect 13 further comprises transmitting an indication of the IC assumption to the one or more other UEs.

In Aspect 15, the method of any of Aspects 1 to 14 further comprises receiving, from the base station, an indication of a demodulation reference signal, DMRS, index assigned to the sidelink communication and an indication of a DMRS index assigned to another sidelink communication to which overlapping resources have been allocated.

In Aspect 16, the method of Aspect 15 further comprises transmitting, to the one or more other UEs, the indication of the DMRS index assigned to the sidelink communication and the indication of the DMRS index assigned to the other sidelink communication to which overlapping resources have been allocated.

Aspect 17 is a method for wireless communication at a base station. The method includes receiving, from a UE, a report of IC capability for a sidelink communication to be transmitted by the UE. The method also includes allocating resources for the sidelink communication based on the reported IC capability. The method further includes transmitting, to the UE, an indication of the resources allocated for the sidelink communication.

In Aspect 18, the indication of allocated resources transmitted to the UE, in Aspect 17, includes an indication of an IC assumption for the allocated resources.

In Aspect 19, allocating resources for the sidelink communication, in Aspect 17 or Aspect 18, comprises allocating resources that overlap at least in part with resources allocated to another sidelink communication when the reported IC capability indicates that IC capability is present for the sidelink communication.

In Aspect 20, the indication of the IC assumption, in Aspect 18, indicates that interference cancellation is assumed.

Aspect 21 relates to a method according to Aspect 19, further comprising assigning orthogonal DMRS to the sidelink communication and to the other sidelink communication to which overlapping resources are allocated.

Aspect 22 relates to a method according to Aspect 21, further comprising transmitting, to the UE, an indication of the assigned DMRS index for the sidelink communication and an indication of the DMRS index assigned to the other sidelink communication.

Aspect 23 is a method for wireless communication at a UE. The method comprises transmitting an indication of IC capability to another UE from which a sidelink communication is to be received and receiving the sidelink communication from the other UE using resources allocated to the other UE based at least in part on the indication of IC capability.

Aspect 24 relates to a method according to Aspect 23, further comprising receiving, from the other UE, an indication of an IC assumption for the allocated resources.

Aspect 25 relates to a method according to Aspect 24, further comprising selectively performing interference cancellation on the received sidelink communication based on the indication of the IC assumption.

Aspect 26 relates to a method according to any of Aspects 23 to 25, further comprising receiving, from the other UE, an indication of a DMRS index assigned to the sidelink communication and an indication of a DMRS index assigned to another other sidelink communication to which overlapping resources have been allocated.

Aspect 27 relates to a method according to Aspect 26, further comprising selectively performing interference cancellation on the received sidelink communication based on the indication of the DMRS indices.

Aspect 28 is an apparatus for wireless communication at a UE comprising at least one means for performing a method according to any of Aspects 1 to 16.

Aspect 29 is an apparatus for wireless communication at a base station comprising at least one means for performing a method according to any of Aspects 17 to 22.

Aspect 30 is an apparatus for wireless communication at a UE comprising at least one means for performing a method according to any of Aspects 23 to 27.

Aspect 31 is an apparatus for wireless communication at a UE comprising at least one processor and memory coupled to the at least one processor, the at least one processor and memory configured to perform a method according to any of Aspects 1 to 16.

Aspect 32 is an apparatus for wireless communication at a base station comprising at least one processor and memory coupled to the at least one processor, the at least one processor and memory configured to perform a method according to any of Aspects 17 to 22.

Aspect 33 is an apparatus for wireless communication at a UE comprising at least one processor and memory coupled to the at least one processor, the at least one processor and memory configured to perform a method according to any of Aspects 23 to 27.

Aspect 34 is a non-transitory computer readable medium storing instructions that, when executed by a processor at a UE, cause the processor to perform a method according to any of Aspects 1 to 16.

Aspect 35 is a non-transitory computer readable medium storing instructions that, when executed by a processor at a base station, cause the processor to perform a method according to any of Aspects 17 to 22.

Aspect 36 is a non-transitory computer readable medium storing instructions that, when executed by a processor at a UE, cause the processor to perform a method according to any of Aspects 23 to 27.

The foregoing disclosure provides illustration and description but is not intended to be exhaustive or to limit the aspects to the precise forms disclosed. Modifications and variations may be made in light of the above disclosure or may be acquired from practice of the aspects.

The words “comprises/comprising” and the words “having/including” when used herein with reference to the present disclosure are used to specify the presence of stated features, integers, steps or components but does not preclude the presence or addition of one or more other features, integers, steps, components or groups thereof.

It is appreciated that certain features of the disclosure, which are, for clarity, described in the context of separate embodiments, may also be provided in combination in a single embodiment. Conversely, various features of the disclosure which are, for brevity, described in the context of a single embodiment, may also be provided separately or in any suitable sub-combination.

1. A method for wireless communication at a user equipment, UE, comprising:
determining an interference cancellation, IC, capability for a sidelink communication, wherein the sidelink communication is to be transmitted to one or more other UEs;
reporting the determined IC capability for the sidelink communication to a base station;
receiving, from the base station, an indication of resources allocated for the sidelink communication based on the reported IC capability; and
transmitting the sidelink communication to the one or more other UEs using the allocated resources.

2. A method as claimed in claim 1, further comprising:
receiving an indication of IC capability from each of the one or more other UEs to which the sidelink communication is to be transmitted; and
wherein determining the IC capability for the sidelink communication comprises determining the IC capability for the sidelink communication based on the one or more received indications.

3. A method as claimed in claim 2, wherein the indication of IC capability received from each UE of the one or more other UEs indicates whether the UE of the one or more other UEs is capable of performing interference cancellation on received sidelink communications.

4. A method as claimed in claim 2, wherein determining the IC capability for the sidelink communication comprises determining that IC capability is present when all of the one or more other UEs are capable of performing interference cancellation on received sidelink communications.

5. A method as claimed in claim 2, wherein the indication of IC capability received from a UE of the one or more other UEs indicates a level of IC capability of the UE of the one or more other UEs.

6. A method as claimed in claim 5, wherein the level of IC capability is a symbol level interference cancellation, SLIC, capability, or a codeword level IC capability.

7. A method as claimed in claim 5, wherein determining the IC capability for the sidelink communication comprises determining a level of IC capability for the sidelink communication based on the level of IC capability of each of the one or more other UEs.

8. A method as claimed in claim 2, wherein:
the sidelink communication is a unicast sidelink communication to be transmitted to one other UE;
the indication of IC capability is received from the one other UE to which the unicast sidelink communication is to be transmitted; and
the determined IC capability for the unicast sidelink communication is determined based on the indication of IC capability received from the one other UE.

9. A method as claimed in claim 2, wherein:
the sidelink communication is a groupcast sidelink communication to be transmitted to a plurality of other UEs;
the indication of IC capability is received from each of the plurality of other UEs to which the groupcast sidelink communication is to be transmitted; and
the determined IC capability for the groupcast sidelink communication is determined based on the indications of IC capability received from the plurality of other UEs.

10. A method as claimed in claim 1, wherein:
the sidelink communication is a broadcast sidelink communication to be transmitted to a plurality of other UEs; and
determining an IC capability for the sidelink communication comprises determining that IC capability is absent for the broadcast sidelink communication.

11. A method as claimed in claim 1, wherein:
the sidelink communication is a broadcast sidelink communication to be transmitted to a plurality of other UEs; and
determining an IC capability for the sidelink communication comprises determining a IC capability for the broadcast sidelink communication based on a sidelink application associated with the broadcast sidelink communication.

12. A method as claimed in claim 1, wherein:
the indication of allocated resources received from the base station includes an indication of an IC assumption for the allocated resources.

13. A method as claimed in claim 12, further comprising:
determining a modulation coding scheme, MCS, for the sidelink communication based on the IC assumption for the allocated resources; and
transmitting the sidelink communication to the one or more other UEs using the determined MCS.

14. A method as claimed in claim 12, further comprising:
transmitting an indication of the IC assumption to the one or more other UEs.

15. A method as claimed in claim 14, further comprising:
receiving, from the base station, an indication of a demodulation reference signal, DMRS, index assigned to the sidelink communication and an indication of a DMRS index assigned to another sidelink communication to which overlapping resources have been allocated.

16. A method as claimed in claim 15, further comprising:
transmitting, to the one or more other UEs, the indication of the demodulation reference signal, DMRS, index assigned to the sidelink communication and the indication of the DMRS index assigned to the other sidelink communication to which overlapping resources have been allocated.

17. A method for wireless communication at a base station, comprising:
receiving, from a user equipment, UE, a report of interference cancellation, IC, capability for a sidelink communication to be transmitted by the UE;
allocating resources for the sidelink communication based on the reported IC capability; and
transmitting, to the UE, an indication of the resources allocated for the sidelink communication.

18. A method as claimed in claim 17, wherein the indication of allocated resources transmitted to the UE includes an indication of an interference cancellation, IC, assumption for the allocated resources.

19. A method as claimed in claim 18, wherein allocating resources for the sidelink communication comprises allocating resources that overlap at least in part with resources allocated to another sidelink communication when the reported IC capability indicates that IC capability is present for the sidelink communication.

20. A method as claimed in claim 19, wherein the indication of the IC assumption indicates that interference cancellation is assumed.

21. A method as claimed in claim 19, further comprising:
assigning orthogonal demodulation reference signals, DMRS, to the sidelink communication and to the other sidelink communication to which overlapping resources are allocated.

22. A method as claimed in claim 21, further comprising:
transmitting, to the UE, an indication of the assigned DMRS index for the sidelink communication and an indication of the DMRS index assigned to the other sidelink communication.

23. A method for wireless communication at a user equipment, UE, comprising:
transmitting an indication of interference cancellation, IC, capability to another UE from which a sidelink communication is to be received; and
receiving the sidelink communication from the other UE using resources allocated to the other UE based at least in part on the indication of IC capability.

24. A method as claimed in claim 23, further comprising:
receiving, from the other UE, an indication of an IC assumption for the allocated resources.

25. A method as claimed in claim 24, further comprising:
selectively performing interference cancellation on the received sidelink communication based on the indication of the IC assumption.

26. A method as claimed in claim 24, further comprising:
receiving, from the other UE, an indication of a demodulation reference signal, DMRS, index assigned to the sidelink communication and an indication of a DMRS index assigned to another other sidelink communication to which overlapping resources have been allocated.

27. A method as claimed in claim 25, further comprising:
selectively performing interference cancellation on the received sidelink communication based on the indication of the DMRS indices.

28. An apparatus for wireless communication at a user equipment, UE, comprising:
means for determining an interference cancellation, IC, capability for a sidelink communication, wherein the sidelink communication is to be transmitted to one or more other UEs;
means for reporting the determined IC capability for the sidelink communication to a base station;
means for receiving, from the base station, an indication of resources allocated for the sidelink communication based on the reported IC capability; and
means for transmitting the sidelink communication to the one or more other UEs using the allocated resources.

29. An apparatus for wireless communication at a base station, comprising:
means for receiving, from a user equipment, UE, a report of interference cancellation, IC, capability for a sidelink communication to be transmitted by the UE;
means for allocating resources for the sidelink communication based on the reported IC capability; and
means for transmitting, to the UE, an indication of the resources allocated for the sidelink communication.

30. An apparatus for wireless communication at a user equipment, UE, comprising:
means for transmitting an indication of interference cancellation, IC, capability to another UE from which a sidelink communication is to be received; and
means for receiving the sidelink communication from the other UE using resources allocated to the other UE based at least in part on the indication of IC capability.
